(19) United States
(12) Patent Application Publication
(10) Pub. No.: US 2026/0297925 A1
(43) Pub. Date: Oct. 1, 2026

(54) A METHOD FOR SECURING TWO UPRIGHT MEMBERS AND A JOINING DEVICE-AND-CONNECTOR ASSEMBLY

(71) Applicant: AUTOSTORE TECHNOLOGY AS, Nedre Vats (NO)

(72) Inventor: Trond Austrheim, Etne (NO)

(21) Appl. No.: 19/477,576

(22) PCT Filed: May 1, 2024
(86) PCT No.: PCT/EP2024/061980

§ 371 Date: Oct. 22, 2025

(30) Foreign Application Priority Data
May 5, 2023 (NO) 20230530

(51) Int. Cl. E04B 1/24; B65G 1/04

(52) U.S. Cl. CPC E04B 1/2403; B65G 1/04; E04B 2001/2415

(57) ABSTRACT

The disclosure relates to a joining device-and-connector assembly (80) comprising a joining device (20) for joining two upright members (102a, 102b) of a framework structure such that they are aligned, each upright member (102a, 102b) comprising an outward facing slot (74a, 74b) extending in longitudinal direction of the upright member (102a, 102b), and connector (51) for connecting two sets (27, 31) of secured upright members. The joining device (20) comprises two plate-shaped parts (30, 40), one of these being configured for inserting in the slot (74a, 74b) associated with the upright members (102a, 102b). A section of the outer wall (72a, 72b) of the respective upright member (102a, 102b) is clamped between the two plate-shaped parts (30, 40). The assembly further comprises means for coupling the first (30) and the second (40) plate-shaped parts such that the upright members (102a, 102b) are joined and a set (27, 31) of joined upright members is created, wherein the connector (51) comprises a beam (51) that extends between and connects the joining device (20) of the first set (27) of joined upright members with another joining device (21) of a parallel, adjacent second set (31) of joined upright members. The disclosure further relates to a method for securing two upright members (102a, 102b) of a framework structure (100).

The present disclosure primarily relates to a method for securing two vertically aligned, upright members.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a, 404a for vertical transportation of storage containers 106, e.g. raising a storage container 106 from, and lowering a storage container 106 into, a storage column 105. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference number. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

In a building housing a conventional three-dimensional storage system, such as that shown in FIG. 1, it is desirable to optimally use available space.

Furthermore and as discussed above, a framework structure of the storage system comprises parallel upright members that support rails having tracks for the wheels of container handling vehicles. The upright members also have a function to guide the vertically moving lifting frame part of the vehicle. Accordingly, the upright members must be manufactured without dimensional deviations. In a related context, the upright members must maintain mutual alignment while the framework structure is being assembled and once said structure is in use.

In view of the above, it is desirable to provide a solution that solves or at least mitigates one or more of the aforementioned issues belonging to the prior art.

### SUMMARY

This summary is provided to introduce in simplified form a selection of concepts that are further described herein. The summary is not intended to identify key or essential features of the disclosure.

The present disclosure is set forth and characterized in the independent claims, while the dependent claims describe other optional characteristics of the disclosure.

One aspect of the disclosure relates to a joining device-and-connector assembly in accordance with claim 9.

By providing the joining device-and-connector assembly as defined above, a cost-efficient solution for significantly increasing useful height of the storage space of the system is obtained. Obviously, a heightened storage space should lead to improved overall storage system economy. In addition, no specific training is necessary for the workers assigned to this particular moment of the system installation. In this context, installation may be carried out without special tools.

Furthermore and by virtue of the assembly of the disclosure, the sets of joined, aligned upright members are straight and provided at a correct distance relative to other set of upright members of the installed framework structure.

The proposed solution is compatible with the existing design of the storage and retrieval system such that it is possible to retrofit the existing systems with the joining device-and-connector assembly of the disclosure and introduce sets of joined and aligned upright members, ultimately resulting in increased useful height of the storage system.

Another aspect of the disclosure relates to a method for securing two upright members by means of the joining device-and-connector assembly. For the sake of brevity, advantages discussed above in connection with the joining device-and-connector assembly may also be associated with the corresponding method and are not further discussed. Here, it is to be construed that the sequence of method steps in the method claims may be effectuated in any given order.

In one aspect, the joining device-and-connector assembly of the present disclosure is for use in the context of the framework structure comprising upright members—the assembly is installed when the upright members are vertically oriented.

In a related aspect, the assembly of the present disclosure is for use in the context of a storage volume comprising storage columns for storing stacks of goods holders. These storage columns are arranged in rows between the upright members.

In another aspect, said assembly is for use in the context of a rail system arranged across and forming part of the framework structure. More specifically, the upright members, joined and secured by means of the assembly, support the rail system. Here, a plurality of remotely operated vehicles travels on the rail system and raises goods holders from, and lowers goods holders into, the storage columns, and is also used to transport the goods holders above the storage columns. During this transport, the remotely operated vehicles move in a plane which is parallel to a horizontal plane.

In this context, the assembly of the present disclosure is for use with various types of container handling vehicles, for instance a cantilever-based container handling vehicle or a container handling vehicle having internally arranged cavity.

In one aspect, the assembly is for use in the context of a SDG-based rail system. Here, SDG stands for Single/Double Grid. This design provides a single rail track along one axis and a double rail track along the other axis. Utilizing a single rail in one direction requires the meeting robots to have a cell between them.

In another aspect, the joining member-and-connector assembly of the present disclosure is for use in the context of a DDG-based rail system. Here, DDG stands for Double/Double Grid. This design provides a double rail track in all directions allowing robots to pass each other in all directions.

For the purposes of this application, the term “container handling vehicle” used in “Background and Prior Art”-section of the application and the term “remotely operated vehicle” used in the rest of the application text are synonymous and define an autonomous wheeled vehicle operating on a rail system arranged across the top of the framework structure being part of an automated storage and retrieval system.

Analogously, the terms “storage container” and “storage bin” used in “Background and Prior Art”-section of the application and the term “goods holder” used in the rest of the application text are synonymous and define a vessel for storing items. In a related context, the goods holder of the present application can be any one of a bin, a tote, a pallet, a tray or similar. Different types of goods holders may be used in the same automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position close to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the disclosure. The drawings show embodiments of the disclosure, which will now be described by way of example only, where:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3a is a perspective view of a prior art container handling vehicle having a cantilever for carrying storage containers underneath.

FIG. 3b is a perspective view, seen from below, of a prior art container handling vehicle having an internally arranged cavity for carrying storage containers therein.

FIG. 4 is a cross-sectional view of an upright member for use with the assembly of the present disclosure.

FIG. 5a is a perspective view showing a joining device in accordance with an embodiment of the present disclosure.

FIG. 5b is a perspective view showing a connector in accordance with an embodiment of the present disclosure.

FIG. 6a is a perspective view showing a joining device and a connector when applied to an upright member.

FIG. 6b is a cross-sectional view of a detail of FIG. 6a.

FIG. 7 is a perspective view showing a section of a framework structure with a joining device-and-connector assembly shown in FIGS. 5-6 installed within the framework structure.

### DETAILED DESCRIPTION

In the following, embodiments of the disclosure will be discussed in more detail with reference to the appended drawings. It should be understood, however, that the drawings are not intended to limit the disclosure to the subject-matter depicted in the drawings.

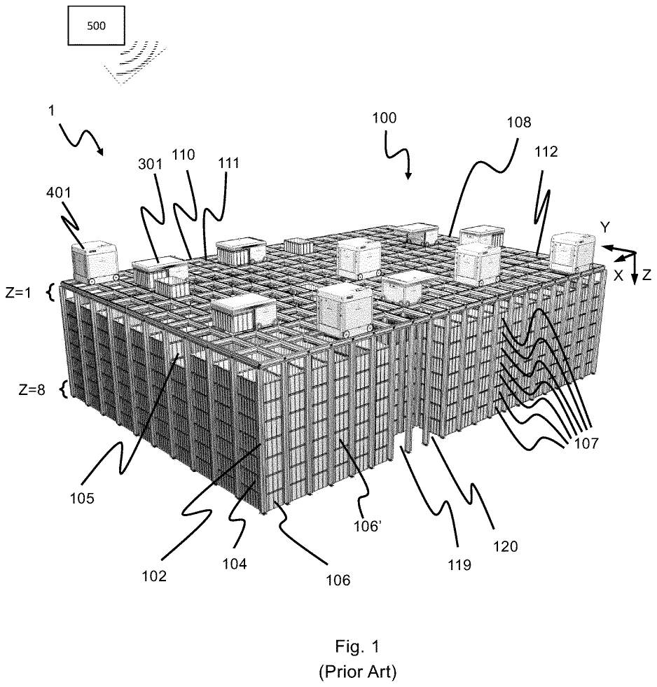

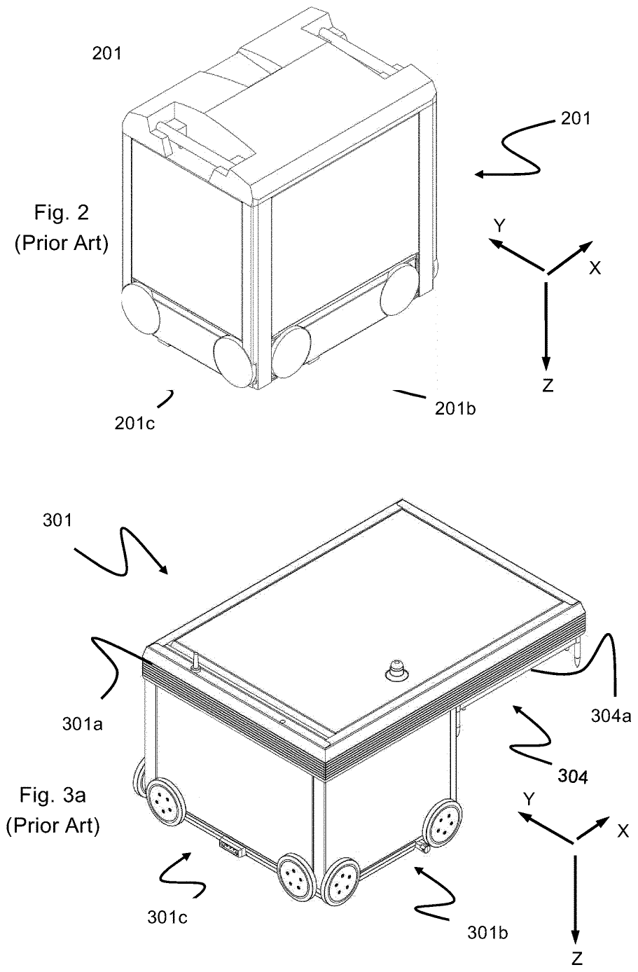

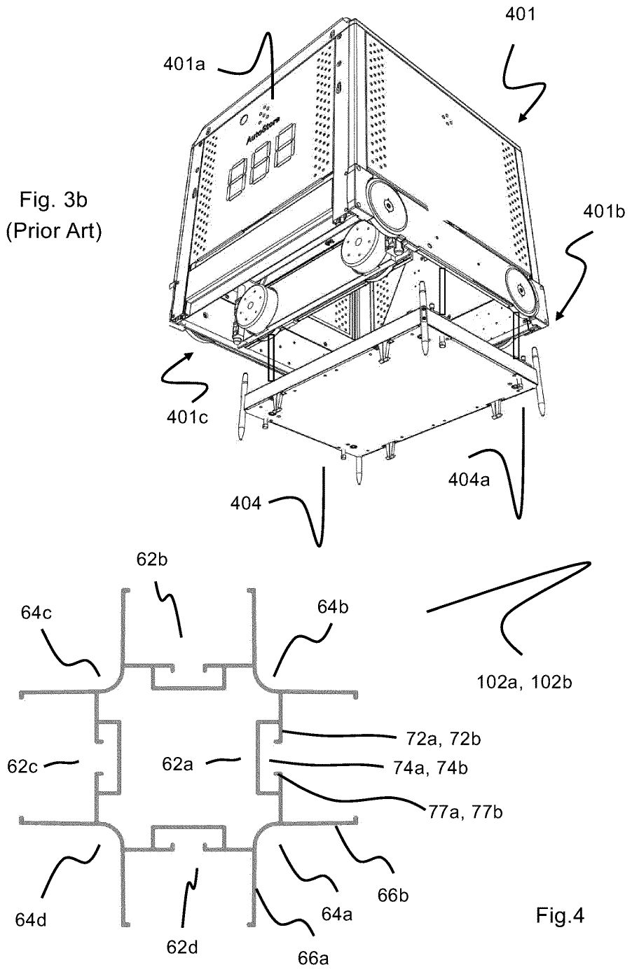

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

Various aspects of the present disclosure will now be discussed in more detail with reference to FIGS. 4-7.

FIG. 4 is a cross-sectional view of an upright member 102a, 102b for use with the assembly of the present disclosure. As seen, the upright member 102a has four sides 62a-62d arranged in a rectangular manner. An outward facing slot 74a, 74b extends in longitudinal direction of the upright member 102a, 102b. In the shown embodiment, the slot 74a, 74b is T-shaped.

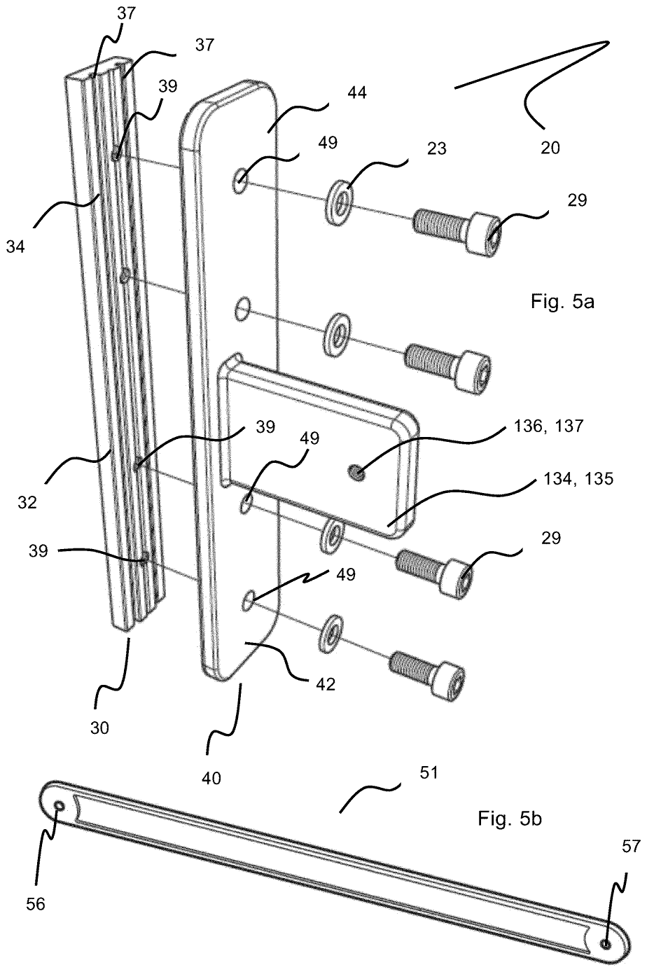

This slot 74a, 74b is for receiving a first plate-shaped part (shown and discussed in conjunction with FIG. 5a) of the assembly of the disclosure. A section of an outer wall 72a, 72b of the upright member 102a, 102b for clamping between a first and a second plate-shaped parts is also shown. In this context, said section 72a, 72b comprises a pair of ridges 77a, 77b for mating with longitudinally extending grooves arranged on a side of the first plate-shaped part.

As seen, central portion of the upright member 102a is hollow. Each of the four corner portions 64a-64d of the upright member 102a is concave. Each corner portion 64a-64d is associated with two, mutually perpendicular flanges 66a-66b. These flanges 66a-66b act as guides for the goods holders being vertically transported by the remotely operated vehicles.

FIG. 5a is a perspective view showing a joining device in accordance with an embodiment of the present disclosure, said joining device being a part of a joining device-and-connector assembly of the present disclosure. The joining device 20 is for joining two aligned upright members of a framework structure (100; shown and discussed in connection with FIG. 7). With further reference to FIG. 1, the framework structure provides a storage volume with storage columns for storing goods holders. A rail system of the framework structure overlies said upright members.

Turning back to FIG. 5a, the joining device 20 comprises a first, plate-shaped part 30, wherein a lower portion 32 of the first, plate-shaped part 30 is configured for inserting in the slot (shown in FIG. 4) associated with the first upright member 102a and an upper portion 34 of the first, plate-shaped part 30 is configured for inserting in the slot associated with the second upright member 102b.

The joining device 20 further comprises a second, plate-shaped part 40, wherein a lower portion 42 of the second plate-shaped part 40 is configured for abutting a section of an outer wall (shown in FIG. 4) of the first upright member (102a; shown for instance in FIG. 7) such that the section of the outer wall is clamped between lower portions 32, 42 of the first and the second plate-shaped parts 30, 40 and an upper portion 44 of the second plate-shaped part 40 is configured for abutting a section of an outer wall of the second upright member (102b; shown for instance in FIG. 7) such that said section of the outer wall is clamped between upper portions 34, 44 of the first 30 and the second 40 plate-shaped parts.

The joining device 20 further comprises means for coupling the first 30 and the second 40 plate-shaped parts such that the upright members (102a, 102b in FIG. 7) are joined and a first set (27 in FIG. 7) of joined upright members is created. Thus created first set comprises two upright members (102a, 102b in FIG. 7).

Means for coupling the first 30 and the second 40 plate-shaped parts comprises at least one aperture 39, 49 arranged in each portion 32, 34, 42, 44 of both plate-shaped parts 30, 40. Said apertures may be embodied as through-holes. The through-holes 39 arranged in the first plate-shaped part 30 may be internally threaded. Said means for coupling further comprises bolts 29. Optionally, washers 23 may also be used.

Still with reference to FIG. 5a, two through-holes 39, 49 are arranged in both portions 32, 34, 42, 44 of each plate-shaped part 30, 40. As seen, all through-holes 39, 49 of both portions 32, 34, 42, 44 of each plate-shaped part 30, 40 are vertically aligned.

One side of the first plate-shaped part 30 comprises a pair of longitudinally extending grooves 37 for mating with corresponding ridges of an outer wall section (72a, 72b; shown and discussed in FIG. 4). In this way, correct positioning of the first plate-shaped part 30 as well as its aligning with the second shape part 40 is facilitated. In a related embodiment (not shown) the second plate-shaped part 40 could also have longitudinally extending grooves for mating with further ridges (not shown in FIG. 4) of the upright member, said ridges extending in a direction opposite to the direction of extension of the ridges 77a, 77b shown in FIG. 4.

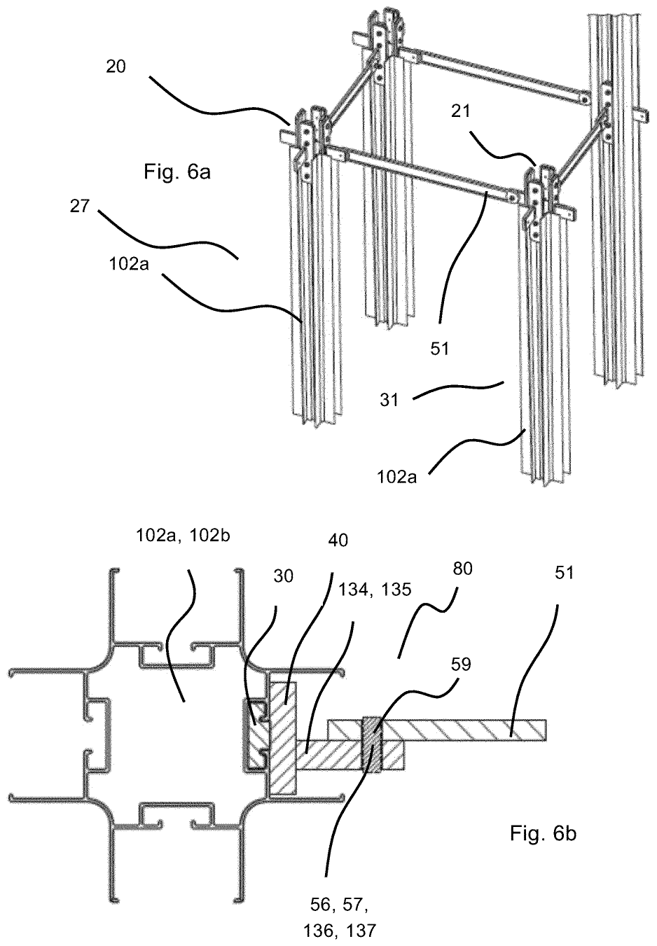

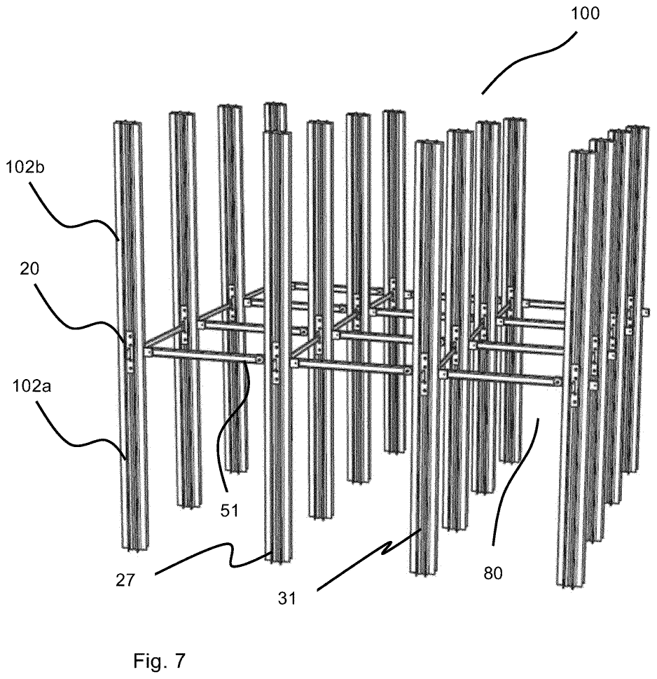

Turning back to FIG. 5a, the joining device 20 comprises a tab 134, 135 that extends perpendicularly from a face of the second plate-shaped part 40. The tab 134, 135 comprises an aperture 136, 137 for connecting two sets 27, 31 of joined upright members by means of connector of FIG. 5b. This is described in greater detail in connection with FIGS. 6a-6b. In a related embodiment (not shown), the tab extends perpendicularly from a face of the first plate-shaped part and the second plate-shaped part has an opening congruent with a cross-section of the tab such that said tab may pass through said opening.

Turning once again back to FIG. 5a, the tab 134, 135 is provided between the through-holes 49 associated with the respective portion 42, 44. Also, the tab 134, 135 is arranged offset relative to the vertically aligned through holes 49.

FIG. 5b is a perspective view showing a connector in accordance with an embodiment of the present disclosure, said connector being a part of a joining device-and-connector assembly of the present disclosure. The connector 51 is for connecting two sets (27, 31; shown for instance in FIG. 7) of secured upright members. As shown in FIG. 6a (discussed further below), the connector 51 of FIG. 5b comprises a beam 51 that extends between and connects the joining device 20 of the first set 27 of joined upright members with another joining device 21 of a parallel, adjacent second set 31 of joined upright members. It is to be noted that only one upright member of each set 27, 31 is shown in FIG. 6a.

Still with reference to FIG. 5b, the beam 51 is I-shaped and through holes 56, 57 are arranged at both end sections of said I-beam 51. Here, other beam designs are conceivable, such as H-beam or C-beam. The beam 51 is sized to fit below the footprint of the rail shown in FIG. 1. Accordingly, its length corresponds approximately to the length of a side of a grid access opening (112; shown in FIG. 1). Obviously, there are two lengths of such beams as the grid access opening has rectangular shape. As regards width of the connector beam 51, it could correspond approximately to distance between two adjacent parallel flanges (66a-66b; shown in FIG. 4). These beams 51 could also act as guides for the goods holders being vertically transported by the remotely operated vehicles. Beams and flanges could also interact in order to add some extra resistance to undesirable twisting.

FIG. 6a is a perspective view showing a joining device 20, 21 and a connector 51 when applied to an upright member 102a whereas FIG. 6b is a cross-sectional view of a detail of FIG. 6a. With reference to FIGS. 6a-6b, the beam 51 is attached to each tab 134, 135 by positioning the beam 51 such that apertures 136, 137 of the tab 134, 135 and apertures 56, 57 at the end sections of the beam 51 are aligned. Subsequently, the beam 51 and the tab 134, 135 are fastened, typically by means of a suitable bolt 59.

FIG. 7 is a perspective view showing a section of a framework structure 100 with a joining device-and-connector assembly 80 shown in FIGS. 5-6 installed. The framework structure 100 comprises a plurality of sets 27, 31 of upright members 102a, 102b making up a storage volume with storage columns for storing goods holders 106. The framework structure 100 supports an overlying rail system (not shown). Said framework structure 100 is a part of an automated storage and retrieval system (not shown), functionally basically identical to the system shown in FIG. 1.

Still with reference to FIG. 7, two upright members 102a, 102b are secured by first super posing a first 102a and a second 102b upright members, subsequently providing a joining device 20 discussed in connection with FIG. 5a, followed by, joining the first 102a and the second 102b upright members by means of said device 20 such that a first set 27 of joined upright members is created, and ultimately, connecting the joining member 20 of the first set 27 of joined upright members with another joining member 21 of a parallel, adjacent second 31 set of joined upright members, typically by means of a connector 51 discussed in connection with FIGS. 6a-6b. Typically, the first and the second upright members 102a, 102b are joined while in a vertical orientation. In the same context, the first set 27 of joined upright members is connected with the second set 31 of joined upright members while both sets 27, 31 are in a vertical orientation. Once the framework structure is in place, a network of joining devices 20, 21 each being associated with a set of joined upright members, is achieved. Each set is connected with up to four other sets by means of a connector beam 51.

By providing the joining device-and-connector assembly 80 as described above, a cost-efficient solution for significantly increasing useful height of the storage space is obtained. A heightened storage space should lead to improved overall storage system economy.

As inferable from above, no specific training is necessary for the workers installing the system having an increased height. In this context, installation may be carried out without special tools.

Once installed, the sets 27, 31 of joined, vertically aligned upright members 102a, 102b are straight and provided at a correct distance relative to one another.

The proposed solution is compatible with the existing design of the storage and retrieval system such that it is possible to retrofit the existing systems with the joining device-and-connector assembly 80 of the disclosure.

In the preceding description, various aspects of the joining device-and-connector assembly according to the disclosure have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present disclosure.

### LIST OF REFERENCE NUMBERS

1 Storage and retrieval system
20 Joining member
21 Another joining member
23 Washer
27 First set of joined upright members
29 Coupling bolts
30 First plate-shaped part
31 Second set of joined upright members
32 Lower portion of the first plate-shaped part
34 Upper portion of the first plate-shaped part
37 Groove in the first plate-shaped part
39 Aperture in the first plate-shaped part
40 Second plate-shaped part
42 Lower portion of the first plate-shaped part
44 Upper portion of the first plate-shaped part
49 Aperture in the second plate-shaped part
51 Connector, beam
56-57 Beam through-holes
59 Bolt
62a-62d Flat sides
64a-64d Corner sections
66a-66b Flanges
72a-72b Section of an outer wall
74a-74b Slot
77a-77b Ridge
80 Joining device-and-connector assembly
134 Tab
135 Another tab
136-137 Tab aperture
100 Framework structure
102 Upright members of framework structure
102a Upright member
102b Upright member
104 Storage grid/Storage volume
105 Storage column
106 Storage container; Goods holder
106′ Particular position of storage container
107 Stack of storage containers
108 Rail system
110 Parallel rails in first direction (X)
111 Parallel rails in second direction (Y)
112 Access opening
119 First port column
201 Container handling vehicle belonging to prior art
201a Vehicle body of the container handling vehicle 201
201b Drive means/wheel arrangement, first direction (X)
201c Drive means/wheel arrangement, second direction (Y)
301 Cantilever-based container handling vehicle belonging to prior art
301a Vehicle body of the container handling vehicle 301
301b Drive means in first direction (X)
301c Drive means in second direction (Y)
304 Lifting device
304a Lifting frame part
401 Container handling vehicle belonging to prior art
401a Vehicle body of the container handling vehicle 401
401b Drive means in first direction (X)
401c Drive means in second direction (Y)
404 Lifting device
404a Lifting frame part
500 Control system
X First direction
Y Second direction
Z Third direction

1-30. (canceled)

31. A method for securing two upright members of a framework structure, each upright member comprising an outward facing slot extending in a longitudinal direction of the upright member, said method comprising:
providing a first and a second upright member,
providing a joining device comprising a first, plate-shaped part, a second, plate-shaped part and means for coupling the first plate-shaped part and the second plate-shaped part,
inserting a lower portion of the first, plate-shaped part in the slot associated with the first upright member,
coupling lower portions of the first and the second plate-shaped parts such that a section of an outer wall of the first upright member is clamped between lower portions of the first and the second plate-shaped parts, and upper portions of the first and the second plate-shaped parts extend beyond an end section of the first upright member,
attaching the second upright member to the first upright member such that an upper portion of the first plate-shaped part is inserted in the slot associated with the second upright member and a section of an outer wall of the second upright member is clamped between upper portions of the first and the second plate-shaped parts, whereby the first and the second upright members are aligned,
coupling upper portions of the first and the second plate-shaped parts whereby a first set of joined upright members is created,
connecting by means of a connector the joining device of the first set of joined upright members with another joining device of a parallel, adjacent second set of joined upright members.

32. A method of claim 31, wherein at least one aperture is arranged in each portion of both plate-shaped parts, the method comprising:
prior to coupling portions of the first and the second plate-shaped parts, positioning the first and the second plate-shaped parts such that the at least one aperture of each portion of the first plate-shaped part is aligned with a corresponding aperture of the second plate-shaped part.

33. A method of claim 31, wherein each joining device comprises at least one tab, the method comprising connecting the at least one tab associated with the joining device with the at least one tab associated with the another joining device.

34. A method of claim 31, wherein the connector is a beam wherein apertures are arranged at both end sections of said beam, the method comprising: prior to attaching the beam to each tab, positioning the beam such that apertures of each tab and apertures at the end sections of the beam are aligned.

35. A method of claim 31, wherein the first and the second upright members are joined while in a vertical orientation.

36. A method of claim 35, wherein the first set of joined upright members is connected with the second set of joined upright members while both sets are in a vertical orientation.

37. A method of claim 31, wherein the framework structure provides a storage volume with storage columns for storing goods holders.

38. A method of claim 31, wherein a rail system of the framework structure overlies said vertically aligned, upright members.

39. A joining device-and-connector assembly comprising:
a joining device for joining two upright members of a framework structure such that they are aligned, each upright member comprising an outward facing slot extending in a longitudinal direction of the upright member,
a connector for connecting two sets of secured upright members, said joining device comprising:
a first, plate-shaped part, wherein a lower portion of the first, plate-shaped part is configured for inserting in the slot associated with the first upright member and an upper portion of the first, plate-shaped part is configured for inserting in the slot associated with the second upright member,
a second, plate-shaped part, wherein a lower portion of the second plate-shaped part is configured for abutting a section of an outer wall of the first upright member such that the section of the outer wall is clamped between lower portions of the first and the second plate-shaped parts and an upper portion of the second plate-shaped part is configured for abutting a section of an outer wall of the second upright member such that the section of the outer wall is clamped between upper portions of the first and the second plate-shaped parts,
means for coupling the first and the second plate-shaped parts such that the upright members are joined and a first set of joined upright members is created, said connector comprising:
a beam that extends between and connects the joining device of the first set of joined upright members with another joining device of a parallel, adjacent second set of joined upright members.

40. A joining device-and-connector assembly of claim 39, wherein said means for coupling the first and the second plate-shaped parts comprises at least one aperture arranged in each portion of both plate-shaped parts.

41. A joining device-and-connector assembly of claim 39, wherein each joining device comprises at least one tab associated with any one of the first and the second plate-shaped parts.

42. A joining device-and-connector assembly of claim 41, wherein the at least one tab extends perpendicularly from a face of the second plate-shaped part.

43. A joining device-and-connector assembly of claim 41, wherein the at least one tab extends perpendicularly from a face of the first plate-shaped part and the second plate-shaped part has an opening congruent with a cross-section of the at least one tab such that the at least one tab may pass through said opening.

44. A joining device-and-connector assembly of claim 41, wherein each tab comprises an aperture.

45. A joining device-and-connector assembly of claim 44, wherein the beam is I-shaped and through holes are arranged at both end sections of said beam.

46. A joining device-and-connector assembly of claim 45, wherein said assembly comprises a nut-and-bolt unit for attaching the beam to each tab when through holes of each tab and of the end sections of the beam are aligned.

47. A joining device-and-connector assembly of claim 39, wherein said means for coupling the first and the second plate-shaped parts comprises bolts and through-holes arranged in the first and the second plate-shaped parts, wherein the through-holes arranged in the first plate-shaped part are internally threaded.

48. A joining device-and-connector assembly of claim 47, wherein two through-holes are arranged in both portions of each plate-shaped part.

49. A joining device-and-connector assembly of claim 48, wherein all through-holes of both portions of each plate-shaped part are vertically aligned.

50. A framework structure for an automated storage and retrieval system, said framework structure comprising a plurality of sets of upright members, each upright member comprising an outward facing slot extending in a longitudinal direction of the upright member, wherein pairs of upright members in vertical alignment are joined together using the joining device-and-connector assembly in accordance with claim 39.
